(19) United States
(12) Patent Application Publication
(10) Pub. No.: US 2016/0217901 A1
(43) Pub. Date: Jul. 28, 2016

(54) TRANSFORMER WITH HIGHLY RESISTIVE CORE

(71) Applicant: NEWTON SCIENTIFIC, INC, Cambridge, MA (US)

(72) Inventor: Robert E. Klinkowstein, Winchester, MA (US)

(21) Appl. No.: 14/916,307

(22) PCT Filed: Sep. 4, 2014
(86) PCT No.: PCT/US14/54003

§ 371 Date: Mar. 3, 2016

Related U.S. Application Data
(60) Provisional application No. 61/873,630, filed on Sep. 4, 2013.

(51) Int. Cl. H01F 27/24; H01J 29/00; H05G 1/10; H01F 27/28

(52) U.S. Cl. CPC H01F 27/24; H01F 27/2823; H01J 29/00; H05G 1/10

(57) ABSTRACT

An electrical transformer is provided. The transformer may include a first winding, a second winding, and a highly resistive magnetic core. The highly resistive magnetic core may provide galvanic isolation between the core material and both the first and second windings.

### BACKGROUND

### Field of the Invention

The present invention relates to electrical transformers, in particular transformers utilizing highly resistive magnetic core materials.

### SUMMARY

An improved electrical transformer is provided in this disclosure. The transformer may include a first winding, a second winding, and a highly resistive magnetic core. The highly resistive magnetic core may provide galvanic isolation between the core material and both the first and second windings.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1a is a front view of a transformer with a highly resistive magnetic core.

FIG. 1b is a sectional side view of the transformer of FIG. 1a.

FIG. 2a is a front view of a transformer with potentials established at nodes on the magnetic core.

FIG. 2b is a sectional side view of the transformer of FIG. 2a.

FIG. 3a is a front view of a transformer with conductive regions on the magnetic core.

FIG. 3b is a sectional side view of the transformer of FIG. 3a.

FIG. 4a is a front view of a transformer with a dielectric material encasing the magnetic core.

FIG. 4b is a sectional side view of the transformer of FIG. 4a.

FIG. 5a is a schematic view of an x-ray system utilizing a transformer having a highly resistive core.

FIG. 5b is a schematic view of another system utilizing a transformer having a highly resistive core.

FIG. 6a is a front view of a transformer with multiple nodes establishing potentials along the highly resistive core.

FIG. 6b is a sectional side view of the transformer of FIG. 6a.

FIG. 7a is a front view of a transformer with a high resistive and low resistive regions of the magnetic core.

FIG. 7b is a sectional side view of the transformer of FIG. 7a.

### DETAILED DESCRIPTION

It is often a requirement of a transformer to provide galvanic isolation between the windings of the transformer for the purpose of transferring power or a signal between two circuits. The two circuits may be at substantially different reference voltages, several kilovolts or higher. For example, an isolation transformer is often used in combination with high voltage power supplies to provide power to an x-ray tube or cathode ray tube device. The primary winding of the isolation transformer is driven by an AC source and maintained at a potential close to ground while the secondary winding is maintained at a high voltage potential. The purpose of the isolation transformer is to provide isolated AC power to the powered device. In the case of the x-ray tube, the secondary winding is connected to the cathode of the x-ray tube and provides power to heat a thermionic cathode. The isolation transformer can also be used to provide an isolated control signal to the device, such as signals to a control grid or electrode. Some terms commonly used when specifying or characterizing the galvanic isolation property of a transformer are: isolation voltage, dielectric strength, standoff voltage, breakdown voltage, hold off voltage, insulating voltage.

In some implementations, the means for providing galvanic isolation in transformers is provided by electrical insulation surrounding or applied directly to the windings and/or surrounding or applied to the magnetic core. These materials are necessary to prevent current flow or high voltage breakdown between the primary and secondary windings, between the windings and the magnetic core, or between the windings and earth. In other implementations, the magnetic core material is a conducting material or material having a resistivity too low to provide sufficient galvanic isolation, for example laminated steel and many ferrites. Some previous systems rely on insulating materials such as plastics, silicone rubbers, oils, varnish, air, insulating gasses, or other insulating liquids to insulate the windings and the magnetic core and to provide galvanic isolation. Some previous systems also use insulating gaps in the magnetic core to achieve galvanic isolation and to prevent high voltage breakdown between transformer windings. These gaps may be filled with air, or dielectric insulators such as plastics, ceramics or insulating oils or gasses.

In one exemplary implementation, the magnetic core material provides substantially all or at least a substantial portion of the insulation necessary for achieving galvanic isolation of the transformer. The highly resistive insulating properties of the magnetic core are used to achieve high voltage isolation between the primary and secondary windings of the transformer. The isolation voltage may be applied directly to the magnetic core and a small DC current is permitted to flow in the core in response to the applied voltage. The resulting voltage drop along the length of the core may provide a smooth voltage distribution which enhances the standoff voltage of the transformer. The smooth voltage distribution provides unique benefits over older implementations for certain applications. The physical design parameters in combination with the resistivity of the core may also be chosen to allow a high voltage potential to be maintained between the windings of the transformer while insuring that the leakage current is maintained at an acceptable level. The acceptable leakage current level depends on the application. In some implementations, the leakage current should be less than the load current. However, there could be implementations in which this is not a requirement. The dielectric properties of the core material may be sufficient to avoid breakdown. This may require the DC bulk resistivity to be sufficiently high to limit the current flow in the core. It also may require good dielectric strength of the core material to prevent breakdown. In addition, the described implementation need not rely on gaps in the magnetic core to achieve an insulating magnetic core assembly. The presence of gaps in the core can have a detrimental effect on the performance of the transformer since these gaps cause flux leakage and reduce coupling between the windings of the transformer.

The described implementation would find use in high voltage power supplies and in particular power supplies that are designed to minimize size, weight and cost. Examples of applications are x-ray generators, portable, handheld or miniature x-ray equipment including XRF analyzers, XRD analyzers, medical imaging devices, security imaging devices, miniature x-ray tube modules, monoblocks, or power supplies. X-ray techniques can also be combined with other portable or handheld analytical techniques such as Raman scattering, Laser induced breakdown spectroscopy, or optical emission spectroscopy. These combined analytical instruments place additional constraints on the size, weight and form factor of the high voltage power supply or x-ray system. The described transformer may provide advantages for these instruments and techniques.

One exemplary implementation is provided in FIGS. 1A and 1B. The transformer 110 has a primary winding 112, a secondary winding 114, and a magnetic core 116 that inductively couples the primary winding 112 and the secondary winding 114. The magnetic core 116 is characterized by having a sufficiently high DC volume resistivity, and correspondingly high DC resistance that it allows good galvanic isolation of the primary and secondary winding. The windings may be made of a suitably good conductor such as copper or aluminum and may be insulated using conventional insulation materials such as PVC, Teflon, silicone, or varnished magnet wire. Alternatively, the windings may be constructed using un-insulated wire. The transformer may be configured as a step-up, step-down, or have a turns ratio of 1:1. The primary and secondary winding 112, 114 are separated by an isolation path length, L, along the magnetic core 116 which is characteristic of the separation between the windings. The DC resistance of the core from midpoint, a, of the primary winding to midpoint, b, of the secondary winding can be calculated, R=(ρ L)/2A, where ρ is the bulk resistivity of the magnetic core material, and A is the cross sectional area of the core. For example, if p=1E10 ohm-cm, L=1 cm, A=0.1 cm², then R=5E10 ohms. However, in many implementations ρ may be greater than 1E10 ohm-cm, L may be less than 5 cm, A may be less than 1 cm², an the isolation voltage may be greater than 1 kV. In the described implementation, the high core resistance may be achieved using a high resistivity Ni-Zn ferrite. Other materials containing nickel, iron or cobalt and having a sufficiently high resistivity could be used. In particular, it has been determined that a suitable core can be fabricated using fully machined CMD5005 ferrite. Older implementations may use insulated windings and insulating coil may form bobbins for achieving galvanic isolation. Older implementations may also use of an air core or insulation gas core to achieve isolation. However, older implementations do not use the high resistivity ferromagnetic core materials to directly provide the insulation sufficient for galvanic isolation, nor to provide the degree of insulation necessary to prevent high voltage breakdown.

In another implementation, shown in FIGS. 2A and 2B, potentials are established at nodes on the magnetic core. The transformer 210 has a primary winding 212, a secondary winding 214, and a magnetic core 216 that inductively couples the primary winding 212 and the secondary winding 214. The magnetic core 216 is characterized by having a sufficiently high DC volume resistivity, and correspondingly high DC resistance that it allows good galvanic isolation of the primary and secondary winding. The nodes at which potential are established are labeled nodes “c” and “d”. These nodes may be connected to reference potentials V1 and V2 respectively. Node “c”, for example, may be proximate to the primary winding 212 and connected to a reference potential, V1, chosen to prevent breakdown between the magnetic core 216 and the primary winding 212. Potential V1 would typically be a voltage approximately equal to the average DC potential of the primary winding 212. Node “d”, for example, may be proximate to the secondary winding 214 and connected to a reference potential, V2, chosen to prevent breakdown between the magnetic core 216 and the secondary winding 214. Potential V2 would typically be a voltage approximately equal to the average DC potential of the secondary winding 214. The voltage difference, V=V1−V2, will cause a small current to flow in the magnetic core material, I=V/R, and will distribute the voltage difference along the isolation path, L, in accordance with the distributed resistance. The voltage distribution will be smooth and may be approximately uniform between the primary and secondary winding. For example, consider a miniature high voltage isolation transformer where V1=0, V2=50 kV, L=1 cm, ρ=1E10 ohm-cm, A=1 cm̂2. Then I=1 micro amp, and the average voltage gradient along the core, V′=V/L, is equal to 50 kV/cm. This type of transformer would find use in portable, handheld or miniature x-ray equipment or instrumentation such as XRF analyzers, XRD analyzers, medical imaging devices, security imaging devices, miniature x-ray tube modules, monoblocks, or power supplies. For many applications a transformer with a leakage current, I, that is less than approximately 10 percent of the total power supply load current would be desirable. For example, a suitable filament isolation transformer for use in a miniature x-ray tube monoblock with a maximum operating current of 100 microamps might have a leakage current, I, of less than 10 microamps. The prior art does not teach applying a potential difference directly to the magnetic core, causing a small current flow in the core, and resulting in a smooth voltage distribution along the magnetic core for the purpose of achieving high voltage isolation between the windings of a transformer.

The features of transformer 210 may be combined with features of the other transformers described in each of the other implementations and as shown in each of the other figures.

Another implementation is shown in FIGS. 3A and 3B, wherein conductive regions are present on the magnetic core 316. The transformer 310 has a primary winding 312, a secondary winding 314, and a magnetic core 316 that inductively couples the primary winding 312 and the secondary winding 314. The magnetic core 316 is characterized by having a sufficiently high DC volume resistivity, and correspondingly high DC resistance that it allows good galvanic isolation of the primary and secondary winding. The conductive regions 318 of the magnetic core 316 may be substantially equipotential regions and could be produced, for example, by conductive coatings, metal foils, or conductive covers. Examples of such materials are foils of copper, aluminum, steel or other metals, metal-loaded epoxies or other conductive polymers, or graphite or other carbon-based materials. The regions are connected by nodes “e” and “f” to potentials V1 and V2 respectively. The regions may be proximate to the primary and secondary windings 312, 314. V1 is chosen to prevent breakdown between the magnetic core and the primary winding. V1 would typically be a voltage approximately equal to the average DC potential of the primary winding 312. V2 is chosen to prevent breakdown between the magnetic core and the secondary winding 314. V2 would typically be a voltage approximately equal to the average DC potential of the secondary winding 314. The windings of the transformer would typically be positioned over (e.g. wound around) or in close proximity to the conductive regions 318. The prior art does not teach the combination of using conductive regions, a highly resistive core, and applying a potential drop to the core for the purpose of obtaining a smooth voltage distribution and reducing high voltage breakdown.

The features of transformer 310 may be combined with features of the other transformers described in each of the other implementations and as shown in each of the other figures.

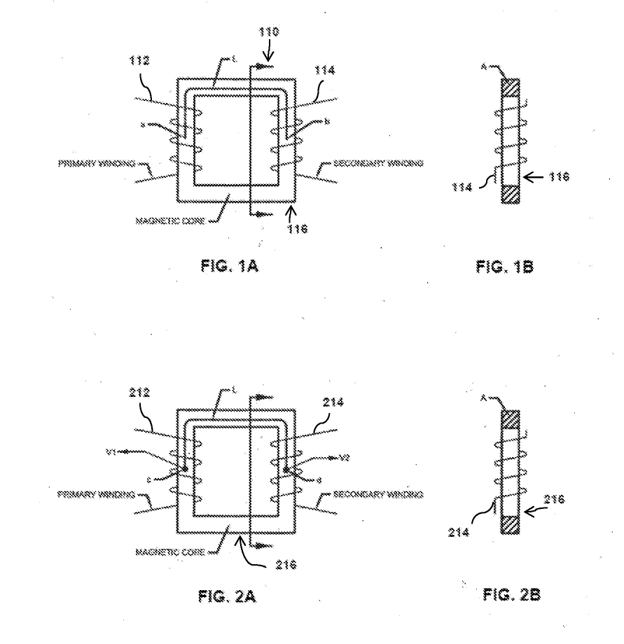

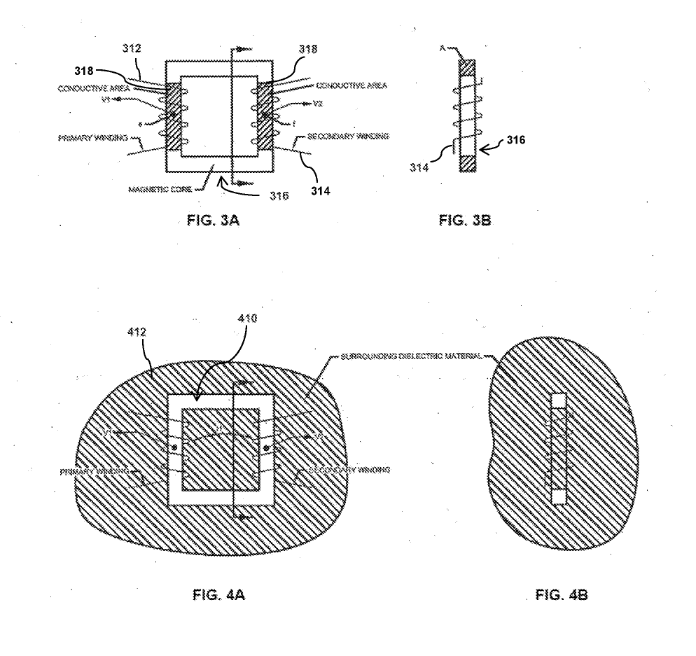

Another implementation is shown in FIGS. 4A and 4B. In this implementation the isolation transformers of FIG. 1A, 2A, or 3A, denoted by reference numeral 410 are further encapsulated or potted in a surrounding dielectric material 412, for example a solid insulating material such as RTV silicone rubber, for example Momentive RTV627. Other encapsulating or potting materials known in the art can also be used including epoxy, polyurethane, plastics, and ceramics. The encapsulating material may further improve the performance of the transformer by reducing or eliminating high voltage breakdown along the interface of the magnetic core and surrounding dielectric 412. The encapsulating material also eliminates or reduces breakdown between primary winding and secondary winding via the path, H, through the surrounding dielectric 412.

In another implementation the transformers of FIGS. 1A, 2A, 3A, could be immersed in an insulating liquid or insulating gas. In this implementation, the surrounding dielectric shown in FIGS. 4A and 4B could be an insulating oil such as Diala AX or an insulating fluid such as Fluorinert. The surrounding dielectric could also be an insulating gas such as sulfur hexafluoride.

The features of transformer 410 may be combined with features of the other transformers described in each of the other implementations and as shown in each of the other figures.

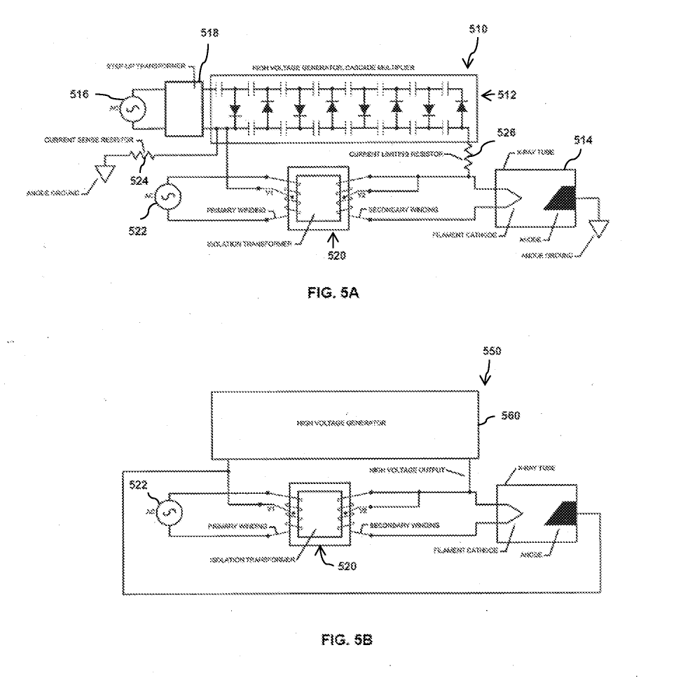

FIGS. 5A and 5B illustrates examples of the use of the transformer in a system configured to make x-rays. In FIG. 5A the system 510 comprises a high voltage generator 512, an x-ray tube 514, the transformer 520, a step-up transformer 512, an AC power source 516 for driving the step-up transformer, an AC power source 522 for driving the transformer. The transformer 520 may be any of the transformers previously or later discussed in this application including any combinations of the features described in any of the particular implementations discussed. The system may also include a current sensing resistor 524 and a current limiting resistor 526 as shown in FIG. 5A. The method, illustrated in FIG. 5A, of connecting V1 and V2 to the high voltage generator insures that the leakage current flowing in the magnetic core of the isolation transformer will not be sensed by the current sensing resistor 524. The transformer could also be used in as system 550 in combination with any high voltage generator 560 as indicated in FIG. 5B. FIGS. 5A and 5B are representative applications and implementations for the transformer. These would find use in x-rays systems and devices, including handheld, portable or bench top instruments.

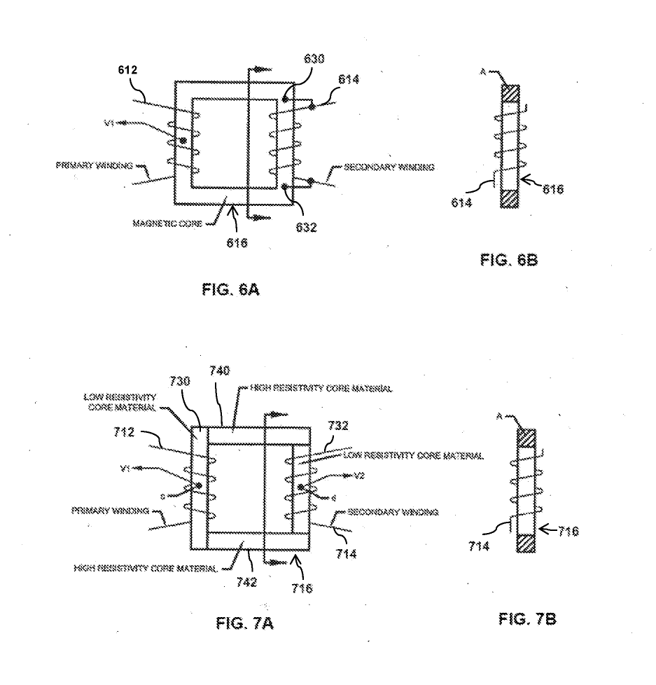

In yet another implementation, multiple nodes on the highly resistive core are used to establish potentials along the core that are advantageous to the performance of the transformer. These nodes may, for example, be connected to the winding terminations as exemplified in FIGS. 6A and 6B. The transformer 610 has a primary winding 612, a secondary winding 614, and a magnetic core 616 that inductively couples the primary winding 612 and the secondary winding 614. The magnetic core 616 is characterized by having a sufficiently high DC volume resistivity, and correspondingly high DC resistance that it allows good galvanic isolation of the primary and secondary winding. Examples of the multiple nodes are labeled at node 630 and node 632 on the secondary winding 614. This type of configuration is advantageous in transformers that generate high voltages and where high voltage breakdown between the winding and the magnetic core can be a mode of failure, for example high voltage step-up transformers. Connecting the winding terminations directly to the core as shown in FIG. 6 establishes a voltage distribution along the core that substantially matches or is similar to the voltage distribution along the length of the winding. This condition is favorable for minimizing the likelihood of breakdown from the winding to the core. The multiple points may be connected to the magnetic core along the secondary winding or the primary winding. The connection may be a physical electrical connection point, such as a solder or weld point. Further, the multiple points may be connected to a high resistivity core material or a low resistivity core material. A transformer of the type shown in FIG. 6 would find application where high voltage step up transformers are utilized, such as high voltage power supplies.

The features of transformer 610 may be combined with features of the other transformers described in each of the other implementations and as shown in each of the other figures.

In another implementation, the magnetic core may be divided into regions of relatively high resistivity and lower resistivity magnetic material, as shown in FIGS. 7A and 7B. The transformer 710 has a primary winding 712, a secondary winding 714, and a magnetic core 716 that inductively couples the primary winding 712 and the secondary winding 714. The magnetic core 716 is characterized by having a sufficiently high DC volume resistivity, and correspondingly high DC resistance that it allows good galvanic isolation of the primary and secondary winding. The regions of high resistivity 740, 742 may be advantageous for achieving galvanic isolation; the regions of low resistivity 730, 732 may be advantageous for establishing regions of relatively uniform voltage. This type of configuration could be advantageous where amplitude of the AC voltage in the winding is relatively low compared to the isolation voltage.

The high resistivity material may have a ρ greater than 1E10 ohm-cm and the high core resistance may be achieved using a high resistivity Ni-Zn ferrite. In particular, it has been determined that a suitable core can be fabricated using fully machined CMD5005 ferrite. For example, if ρ=1E10 ohm-cm, L=1 cm, A=0.1 cm², then R=5E10 ohms. However, in many implementations ρ may be greater than 1E10 ohm-cm, L may be less than 5 cm, A may be less than 1 cm², an the isolation voltage may be greater than 1 kV. The low resistivity material may have a ρ less than 1 E4 ohm-cm and the low core resistance may be achieved using a MnZn ferrite.

The primary winding 712 may be positioned over (e.g. wound around) or in close proximity to the low resistivity region 730. The low resistivity region 730 may be connected (e.g. in physical contact and/or electrical connection) with the high resistivity region 740 on one end and connected with the high resistivity region 742 on the other end. Similarly, the secondary winding 714 may be positioned over (e.g. wound around) or in close proximity to the low resistivity region 732. The low resistivity region 732 may be connected (e.g. in physical contact and/or electrical connection) with the high resistivity region 740 on one end and connected with the high resistivity region 742 on the other end. Further, the low resistivity region 732 may have a different size (e.g. length and/or thickness), shape, or resistivity than the low resistivity region 730. In the same manner, the high resistivity region 740 may have a different shape, size, or resistivity than the high resistivity region 732.

The features of transformer 710 may be combined with features of the other transformers described in each of the other implementations and as shown in each of the other figures.

A sample lot of five prototype transformers were constructed using high resistivity ferrite to fabricate the cores. Toroidal cores measuring OD=2.3 cm, ID=1.47 cm, Height=0.77 cm were used for the transformers. The cross sectional area of the cores was A=0.32 cm̂2. The DC bulk resistivity and resistance of the ferrite used in each of the finished cores was measured by applying a 50 kV potential across the core. The measured range of DC resistivity was between 1E11 to 1E12 ohm-cm at 50 kV. The range of resistance, measured across the diameter of each toroid, was approximately 5.4E10 to 5.4E11 ohms at 50 kV. CMD5005 Ni—Zn ferrite material was used to fabricate the cores. All surfaces of the cores were machined to avoid anomalies in material properties at the surface.

Each of the transformers had a primary winding and a secondary winding made of 27 AWG magnet wire with HPN film insulation, 0.0016 inches thick. The center tap of each winding was electrically connected to the ferrite core using silver epoxy. The assemblies are schematically represented by FIG. 7A with nodes “c” and “d” connected to the center taps of the primary and secondary windings 712, 714, respectively.

The prototype transformers were tested for galvanic isolation properties by applying a high voltage potential between the primary winding and the secondary winding. The leakage current flowing from primary to secondary winding through the magnetic core material was measured, and the transformers were observed for any breakdown phenomena. Each of the transformers was immersed in Fluorinert dielectric liquid for during the test. With a voltage of 50 kV was applied between the primary and secondary windings, the measured range of leakage current for the sample lot of transformers was 0.09 to 0.9 microamps. All of the transformers sustained the 50 kV isolation voltage without failure or any signs of high voltage breakdown.

The prototype transformers were cleaned and then individually potted in RTV potting material. The transformers were then retested for galvanic isolation as described in the preceding paragraph. Leakage current from primary to secondary windings was measured. The results were in good agreement with the measurements made in Fluorinert. All of the transformers sustained the 50 kV isolation voltage without failure or any signs of high voltage breakdown.

The features of the implementations described herein may be used in conjunction and/or combined as would be understood from this disclosure. Further, the features of the implementations or combinations thereof may be combined with the features of various X-ray sources including, but not limited to those described in U.S. Pat. No. 7,448,801 and U.S. Pat. No. 7,448,802, each of which are hereby incorporated by reference.

The descriptions and illustrations given in this disclosure are illustrative of the principals and applications of the inventive transformer. It will be recognized by one skilled in the art that many other configurations, variations and modifications are possible.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A transformer utilizing a highly resistive magnetic core.

2. The transformer of claim 1, configured to provide galvanic isolation.

3. The transformer of claim 1 wherein the highly resistive magnetic core is comprised of a highly resistive magnetic core material, wherein the resistivity of the highly resistive magnetic core material is greater than 1E10 ohm-cm.

4. The transformer of claim 1 wherein the highly resistive magnetic core is made from a nickel-zinc ferrite.

5. The transformer of claim 1 wherein the highly resistive magnetic core is made from fully machined ferrite.

6. The transformer of claim 1 wherein galvanic isolation between transformer windings is provided by a highly resistive magnetic core material.

7. The transformer of claim 1 with an isolation voltage of greater than or approximately equal to 1 kV.

8. The transformer of claim 1 with an isolation path length of less than or approximately equal to 5 cm.

9. The transformer of claim 1 with a cross sectional area of less than or approximately equal to 1 cm.

10. (canceled)

11. (canceled)

12. (canceled)

13. (canceled)

14. The transformer of claim 1 comprising a primary winding, a secondary winding, and the highly resistive magnetic core utilizing a highly resistive material.

15. The transformer of claim 14, wherein the magnetic core provides galvanic isolation between the windings.

16. The transformer of claim 15 further comprising one or more galvanic connections to the magnetic core.

17. The transformer of claim 16 further comprising a first galvanic connection to the magnetic core proximate to the primary winding, and a second galvanic connection to the magnetic core proximate to the secondary winding.

18. The transformer of claim 17 wherein the first galvanic connection proximate to the primary winding is maintained at a first predetermined potential, and the second galvanic connection proximate to the secondary winding is maintained at a second predetermined potential.

19. The transformer of claim 18 wherein the first predetermined potential being chosen to prevent electrical breakdown of the primary winding to the magnetic core and the second predetermined potential being chosen to prevent electrical breakdown of the secondary winding to the magnetic core.

20. The transformer of claim 14 wherein the primary winding is positioned over or located proximate a conductive region of the magnetic core.

21. The transformer of claim 14 wherein the secondary winding is positioned over or located proximate a conductive region of the magnetic core.

22. The transformer of claim 14 wherein the primary winding is positioned over or located proximate a first low resistivity region of the magnetic core.

23. The transformer of claim 14 wherein the secondary winding is positioned over or located proximate a second low resistivity region of the magnetic core.

24. The transformer of claim 23 wherein a first end of the first low resistivity region is connected to a first end of the second low resistivity region of the magnetic core.

25. The transformer of claim 24 wherein a second end of the first low resistivity region is connected to a second end of the second low resistivity region of the magnetic core.

26. The transformer of claim 14 wherein the primary winding includes one or more galvanic connections to the magnetic core.

27. The transformer of claim 14 wherein the secondary winding includes one or more galvanic connections to the magnetic core.

28. The transformer of claim 14, wherein the transformer is integrated into an XRF instrument.

29. The transformer of claim 14 wherein the transformer is configured to provide power to a cathode of an x-ray tube.

30. A high voltage power supply for powering a device such as an x-ray tube or cathode ray tube, such power supply comprising a means for generating a high voltage potential, and an isolation transformer utilizing a highly resistive magnetic core for providing galvanic isolation.

31. The high voltage power supply of claim 30 wherein the isolation transformer is coupled to the cathode of the x-ray tube.

32. The high voltage power supply of claim 30 wherein the isolation transformer is coupled to a control electrode of the device.

33. The use of a high voltage power supply of claim 30 in a portable or handheld XRF instrument.

34. An x-ray source comprising an x-ray tube, a high voltage power supply for powering the x-ray tube, such power supply comprising a means for generating a high voltage potential, and an isolation transformer utilizing a highly resistive magnetic core for providing galvanic isolation.

35. (canceled)
